(19) United States
(12) Patent Application Publication
(10) Pub. No.: US 2014/0117658 A1
(43) Pub. Date: May 1, 2014

(54) ASSEMBLY OF ADHESIVE PAPER AND PROCESS OF PRODUCTION THEREOF

(71) Applicant: BRIAN A. TOMLINSON, Pickering (CA)

(72) Inventor: BRIAN A. TOMLINSON, Pickering (CA)

(21) Appl. No.: 13/665,814

(22) Filed: Oct. 31, 2012

(51) Int. Cl. B41F 17/04; B42D 5/04

(52) U.S. Cl. CPC B41F 17/04; B42D 5/04
USPC 283/2; 156/182

(57) ABSTRACT

An assembly of adhesive sheets of paper has two or more sheets, each having an image or data on the first side and a repositionable adhesive on the reverse side, the sheets assembled such that the front of one page contacts the reverse of another, the adhesive holding the assembly together. The adhesive may cover only a portion or all of the reverse side of each sheet. The assembly further may have a backer sheet of which the reverse is covered in adhesive and has a liner to protect the adhesive until use. A process for making the assembly is also disclosed, wherein the sheets are printed with different images and positioned on a printing press which rolls the repositionable adhesive on the reverse of the sheets before assembling the sheets and inserting a backer sheet at chosen intervals.

### FIELD OF INVENTION

The present invention relates to the assembly of paper sheets, and more specifically an assembly of adhesive sheets and a process of production thereof.

### BACKGROUND

Calendars are normally mountable with a pin, tack or nail to a wall, or where the calendar may be taped up, for example to filing cabinets, doors, refrigerators and the like. When it comes time to turn a calendar page, this may require removal and replacement of the pin, tack or nail, weakening or enlarging the hole, or removal and replacement of the tape, potentially leading to tape residue on the surface in question, and possibly wear and tear. The solution of a pin, tack or nail to mount a calendar has limitations in mounting locations, and the use of tape has drawbacks, including unwanted residue. There is a need for a better mounting means for a calendar and other documents that need to be mounted, which require or promote the periodic turning or removal of pages.

The adhesive or ‘sticky’ note, originally developed by 3M under the Post-It™ brand, has become ubiquitous in offices and homes, to removably stick a note to a surface without leaving a residue or removing paint. The adhesive note is a piece of paper having a narrow strip of microsphere adhesive on the reverse side, that is pressure-sensitive and re-adherable. A plurality of adhesive notes are typically formed into stacks. Each note has the same image or no image, as opposed to variable data.

Should the adhesive notes have any printing on them, the usual means is by offset printing on precoated paper. Prior art attempts to apply an adhesive backing to paper which already has a digital print fail when the adhesive is applied during the printing process, as the sheet wraps around the press' printing rollers, causing the press to jam and not allow the digital press to print. As such the print will not “sheet out” properly. In other words, the sheet is fed onto a conveyor belt and into the stacker. If it does not sheet out properly, the paper wraps around the base roller and will build up until the press is stopped or the part breaks.

Adhesive “sticky” notes are typically produced by large rolls of paper being coated with adhesive material, the rolls then being sent to a printing machine which prints a 1 to 4 color design on every page using offset printing on a paper that already has the adhesive applied thereon. Offset printing carries the disadvantage in that relatively large runs are required in order for it to be cost-effective, due to the preparation required. Offset printing requires more set up time than digital printing. Digital printing has come to replace offset as the printing technology of choice for relatively smaller runs, which is generally about 5,000 feet or less.

There is a need for a calendar or such assembly of papers, comprising variable images or other data, to be easily mountable without leaving a residue, and being printed with different images for superior flexibility and customizability.

### SUMMARY

In one embodiment of the invention, there is provided an assembly of adhesive printed sheets comprising two or more printed sheets, each sheet comprising a section of paper having an image or data printed on a first side and having a repositionable adhesive on at least a portion of a reverse side, wherein the sheets are assembled together so the first side of one sheet contacts the reverse side of an adjacent sheet. The adhesive detachably holds the sheets together. Two or more printed sheets have different images or data printed on their respective first sides and are repositionable.

Further disclosed is the assembly having a backer sheet having adhesive on a reverse side. The backer sheet is attached to the last printed sheet in the assembly. Optionally, the backer sheet may have a liner to protect its adhesive in a first non-use mode. The liner is removed prior to using the assembly in a second use mode. In another embodiment, the backer sheet has no adhesive at all.

Further disclosed is the assembly wherein the reverse side of each sheet has an upper portion and a lower portion, wherein the adhesive is in contact with the upper portion, and the lower portion has no adhesive. The adhesive may be a reusable low-tack microsphere adhesive or other repositionable adhesive. In another embodiment, both the upper and lower portions are coated with adhesive.

The assembly may be a calendar, such as a monthly calendar, a weekly calendar, a daily calendar, or flashcards, photos, coupons, drawings, educational material, or any other application having two or more different images or other data. The assembly is especially convenient for customization where the sheets are printed on a digital press.

Further disclosed is a process for creating an assembly of adhesive sheets, the process comprising printing two or more images or other data on a roll of sheets with a press such as a digital press; placing the roll within a printing press having one or more print stations such as a label printing press or other press having a coating station; webbing the printing press with the roll; setting an eye mark or other indication on a reregistration unit of the printing press for alignment and cut positioning; adding a repositionable adhesive to the printing press; positioning an anilox or coating roller in the print station for the adhesive; positioning a tint roller or coating roller in the print station to coat the adhesive to a desired width and thickness; positioning a sheeter in a sheeting station; coating at least a portion of the reverse portion of the sheets with adhesive, cutting the images or data into separate sheets and assembling the sheets into an assembly such that the adjacent sheets adhere to one another.

In another embodiment, repositionable adhesive is added using a coater or printing and coating on a hybrid press.

Further disclosed is the process for creating the assembly wherein the sheets are printed by means of a digital press or other press. Further disclosed in the process wherein the functions of the digital press and printing press are combined in one process or one machine.

Further is the process wherein the repositionable adhesive is a low-tack microsphere adhesive. Also disclosed is the process where the anilox roller is a 100 line anilox roller for flexographic coating, or a 360 line anilox roller for gravure or direct gravure. The coating may also be accomplished using other known coating apparatus.

Further disclosed is the process wherein the sheets are placed on the press unwind shaft image side down and a turn bar is used to turn the images right side up when coating using a flexographic or other coating method. Further disclosed is the process including the step of ensuring the order of the printed sheets is consecutive, such that the order will be reversed and correct after passing through the press.

Also disclosed is the process including the step of cutting the assembly to the desired size on a cutter after the assembly is removed from the stacker. Adding a backer sheet is further contemplated in the additional steps of: placing a roll of a slip sheet backer material on the unwind shaft of the press; positioning a rotary sheeting die or similar cutting tool in the sheeting station; positioning a back slitter in the die station to cut the liner; and running the press, wherein each backer sheet passes the back slitter and receives a back slit; adding the resulting backer sheets to the press for insertion into the assembly; and setting the backer sheet inserter to insert a backer sheet at the desired sheet count.

### BRIEF DESCRIPTION OF FIGURES

FIG. 1a shows a diagram of the operation of a digital press, known in the art, used to print two or more images for one embodiment of the assembly of adhesive paper of the present invention;

FIG. 1b shows a side view of the paper path of the digital press of FIG. 1a;

FIG. 2 shows a side view of a label printing press, known in the art, used to construct one embodiment of the assembly of adhesive paper of the present invention;

FIG. 3 shows a front perspective view of one embodiment of the assembly of adhesive paper of the present invention with a first page corner upturned to show the adjacent page underneath;

FIG. 4 shows a rear perspective view of the assembly embodiment of FIG. 3 with no backer sheet so as to show the reverse side of the sheets;

FIG. 5 shows a rear perspective view of the assembly embodiment of FIG. 3 with the backer sheet attached and the liner upturned for removal; and

FIG. 6 shows a schematic of one embodiment of the process of producing an assembly of adhesive sheets according to the present invention.

### DETAILED DESCRIPTION

The present invention, described below, is an assembly of papers with adhesive on one side wherein two or more adjacent papers have different images or data.

In one embodiment, the assembly is an adhesive calendar, which addresses the problems described above by permitting the calendar to be applied to areas traditionally requiring a pin, tack or nail, and to other areas where tape is required such as walls, filing cabinets, fridges and doors. The adhesive used is a repositionable adhesive which is strong enough to hold the adjacent papers together, but weak enough to allow the papers to be separated without being torn, and such that one or more separated paper may be removably attached to various surfaces, including materials and objects, all the while without leaving a residue on the surface. One example or a repositionable adhesive is low-tack microsphere adhesive. Other examples of adhesives are contemplated so long as they are considered repositionable. This adhesive, on the back of the calendar month sheets, permits the sheet identifying a given month, such as January, to adhere to an adjacent sheet, such as the sheet identifying February, in a 12-month calendar, for example, or any month to be separated from the calendar and mounted on another surface. The calendar may then be repositioned easily to a surface, such as a wall, and each individual sheet identifying a month thereof removed or reattached to the calendar body at will, and be positioned on other surfaces.

The application of the invention is not limited to a calendar but extends to any assembly of adhesive pages where removal and repositioning of pages is desirable, such as counting, alphabet and flashcard applications for students, photo or art albums, memory aids or games, notes or labels having different images, to identify various elements having a common theme, coupons, redemption programs, promotional uses, etc.

Examples of the identification application include the identity of design elements in a room, such as a chair, desk, bed, lamp, etc, wherein a user, such as a designer, contractor or home owner, repositions the sheets in a plurality of locations relative each other to visualize the room concept. If a given position of one sheet needs to be moved, it is easily removed from the first location and adhered (ie: repositioned) to a second location. This process continues until the person is satisfied with the position of a given sheet relative the other sheets and relative the entire design. Another example is the identity of perishable food items in a fridge, such as milk, cheese, leftover dinner, etc, wherein each food is associated with the corresponding page from the assembly and the user marks each page with a best before date. The same goal can be accomplished with another embodiment of the assembly, wherein each paper has a day of the week printed thereon, such as Monday, Tuesday, etc, and the image is associated with the best before date of a given food item. The uses of the assembly of the present invention are numerous.

Due to the process described below, a pre-printed sheet may be treated with the adhesive and assembled into a calendar, for example. This permits printing such as with a digital press or other printer to be used for printing of smaller runs. A digital press for example is optimal for printing smaller runs, and a repositionable adhesive applied after printing creates a functional adhesive calendar assembly. The invention is also not limited to a narrow strip of adhesive on each sheet. Due to the process described below, a wide strip of adhesive may be used or the reverse of the entire sheet may be covered with repositionable adhesive.

In one embodiment, the assembly of the present invention is constructed with two machines, namely a digital press and a label printing press. In another embodiment, not shown, the functions of printing and assembly are combined into one machine or the two machines are linked together by mechanical and/or electrical means.

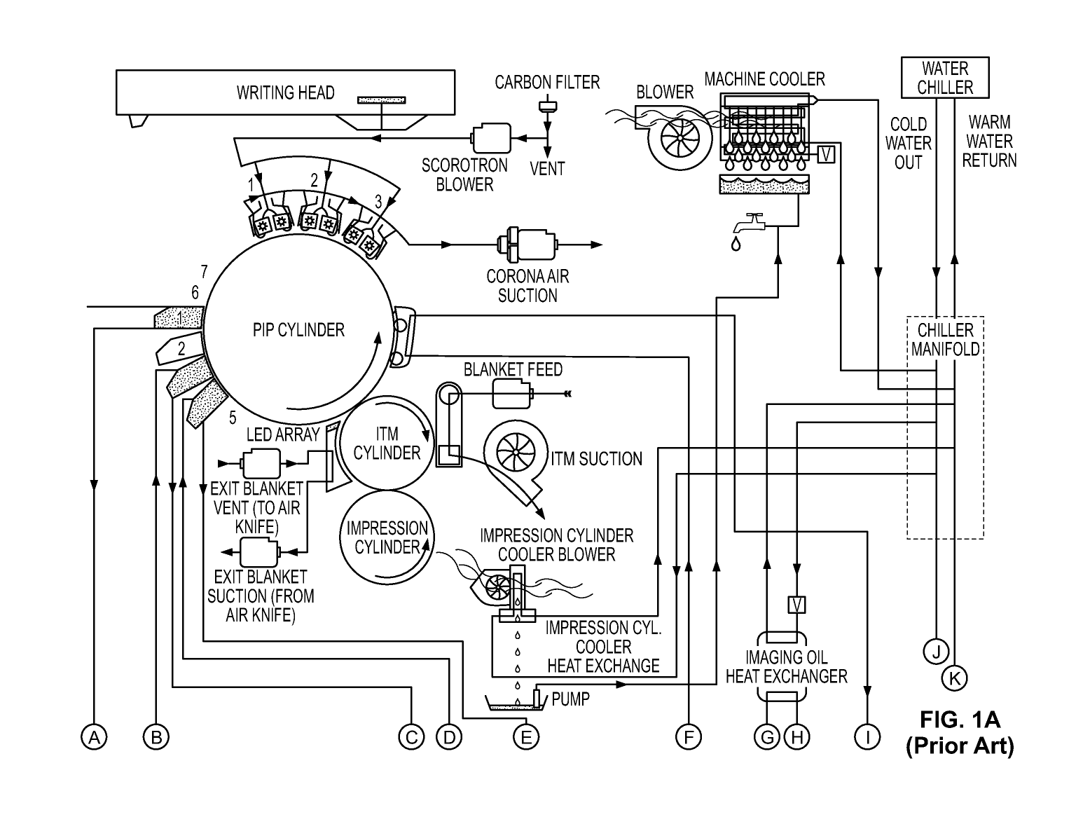

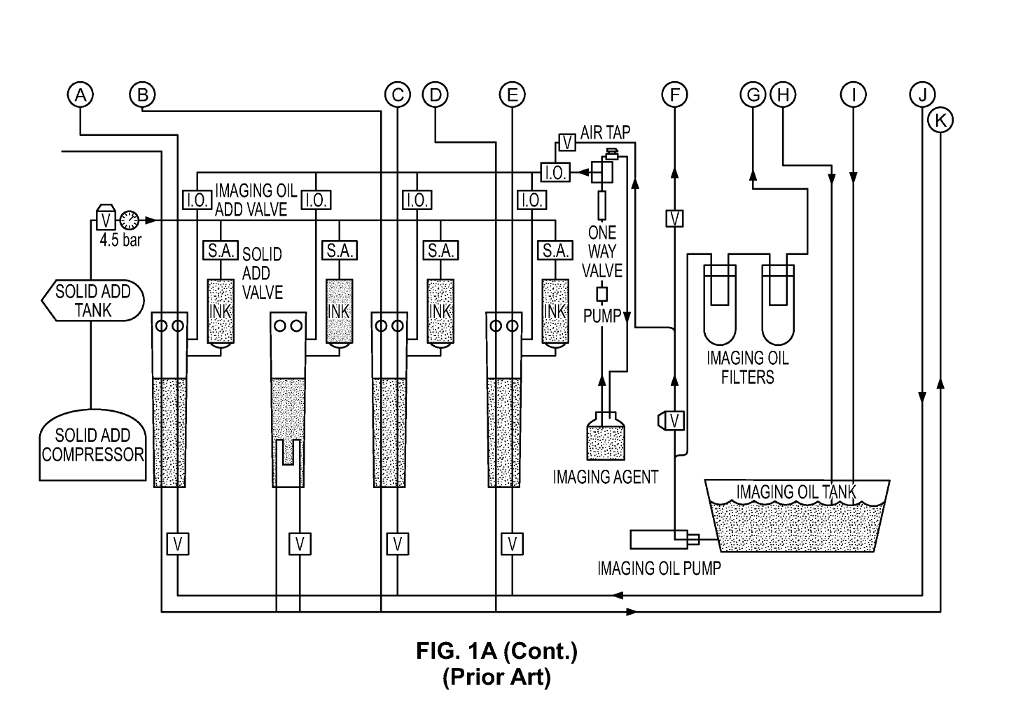

The printing press may be a Hewlett-Packard Indigo™ 4500 Digital Press, the operation flow of which is illustrated at Figures 1a and 1b. Other digital presses and other printing presses are contemplated. The Nilpeter™ FB3300 is a label printing press, the schematics of which are shown in FIG. 2. The digital press prints the different images or other data on two or more adjacent pages and the label printing press assembles the pages as detailed herein, with the adhesive and optional backer sheet.

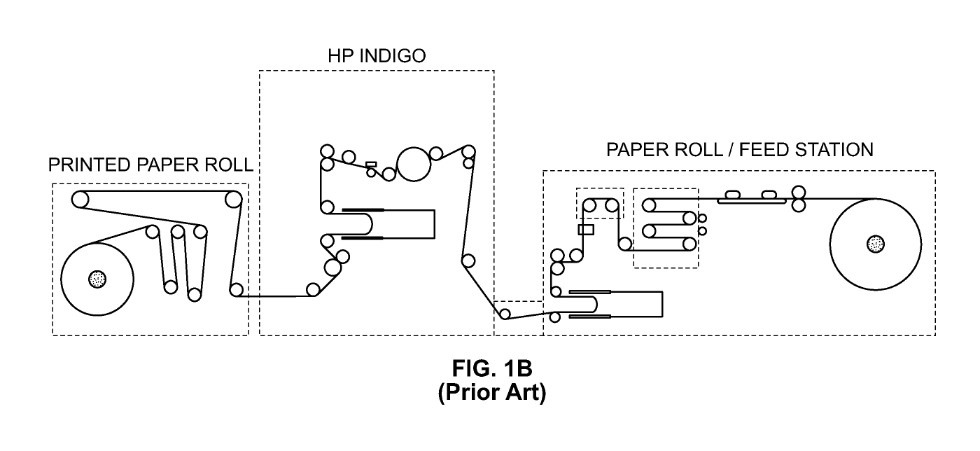

With reference to FIG. 3, the assembly of adhesive paper is shown in a front perspective view. It is formed from a stack 1 of two or more sheets 2, 8, in some embodiments coated or uncoated paper stock of 60 lbs., each sheet 2, 8 having an image on a first side and adhesive on the reverse side (not shown in FIG. 3). For clarity the top sheet is designated 2 and the adjacent sheet is designated 8. Each sheet 2, 8 has adhesive applied across a portion 4 of the reverse side. In one embodiment wherein the assembly is a calendar, adhesive is applied to the reverse of the upper portion 4 of each sheet. On the first side of sheet 2, typically a photo or drawing and a first month (January) is digitally printed, usually with the photo or drawing on the upper portion 4 and the month grid on the lower portion 5. On the first side of the adjacent sheet 8, a photo or drawing and a second month (February) is digitally printed in a similar layout, and so on. In one embodiment, there is little or no adhesive on the reverse of the lower portion 5 of each calendar sheet, such that the lower portion 5, for example, may be lifted to look at and note appointments on subsequent months. When the month is over, typically, the sheet 2 containing the expired month is removed and optionally discarded or recycled by easily peeling sheet 2 away from the adjacent second sheet 8, thereby exposing the next month on sheet 8. Typically for a calendar application the stack will contain 13 sheets, one for each month and a cover page which protects the first month during shipping, plus an optional backer sheet (not shown in FIG. 3).

The optional backer sheet has repositionable adhesive distributed across part or the whole of its reverse surface, so that it may be applied to surfaces and adhere sufficiently such that the calendar remains attached thereon. To form the assembly, each sheet is positioned with its front or first side in the same direction, so that the first side contacts the reverse side of the sheet on top of it. The first calendar month is positioned to contact with the reverse side of the optional cover page. As the sheets are coated with repositionable adhesive, they adhere to each other and form the calendar without the need for a binding, as would be found in calendars of the prior art.

In another embodiment, such as flashcards, a portion less than about the top half of the reverse of each of the sheets is coated with adhesive, such that each sheet is capable of adhering to the adjacent sheet below but may also be removed and attached to a surface, such as a smooth surface, by means of the adhesive backing. In a further embodiment, where for example the cards forming the calendar are meant to be mounted on uneven surfaces such as carpet, in the interests of adherence, the entire back side of each page may be coated with adhesive. Other embodiments may include, but are not limited to, weekly calendars, daily calendars and cartoons, photo and art albums and learning aids such as numbers, letters, symbols or other images or data. Coupons booklets directed to consumers are an interesting application of the assembly disclosed herein.

As the assembly may be manufactured using digital printing, it is capable of having different images in succession. It is therefore highly customizable, and each assembly printed may be unique for a given project. This differentiates the assembly from offset printing, where a larger run of each page, for example 10,000 calendars, must be printed, then the pages collated together in order to efficiently produce a calendar having twelve different months therein. The present invention allows printing and coating one sheet after another, each adjacent sheet having a different image or data, without the requirement to collate.

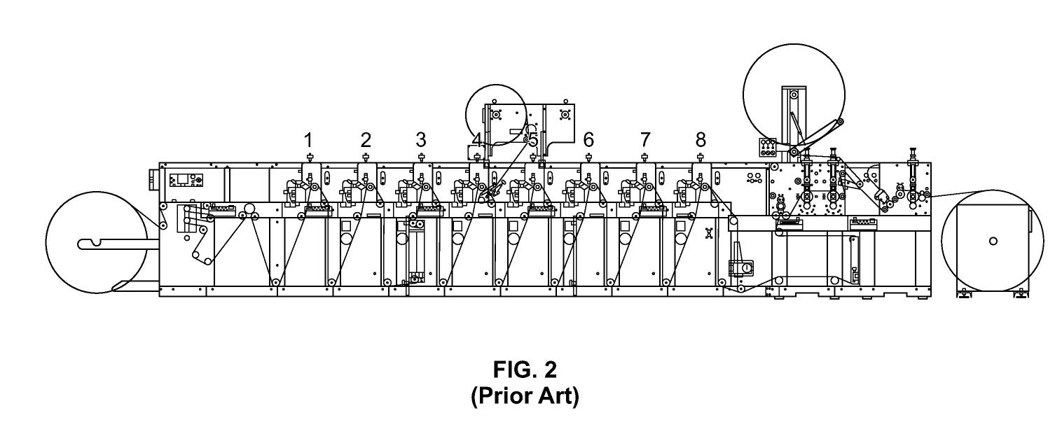

With reference to FIG. 4, the reverse sides of respective calendar sheets 2, 8 are illustrated, and the optional backer sheet is not shown. The stack 1 of two or more pages, comprising a calendar is shown. The reverse side of top sheet 8 has an upper portion 4 which is coated with adhesive 10, and a lower portion 5 which has no adhesive. In this embodiment the upper portion 4 makes up almost half of the length of sheet 8. Adjacent and immediately in front of sheet 8 is the reverse side of sheet 2 which also has an upper portion 4, having a similar coating of adhesive 10, by which means it adheres to the upper portion of the front side of the next adjacent sheet below it, namely sheet 8. Sheet 2 also has a lower portion 5 with no adhesive, which portion may be raised to see the preceding month above, or more typically when in use, the lower portion of sheet 2 may be raised to see the following month, sheet 8, therebelow.

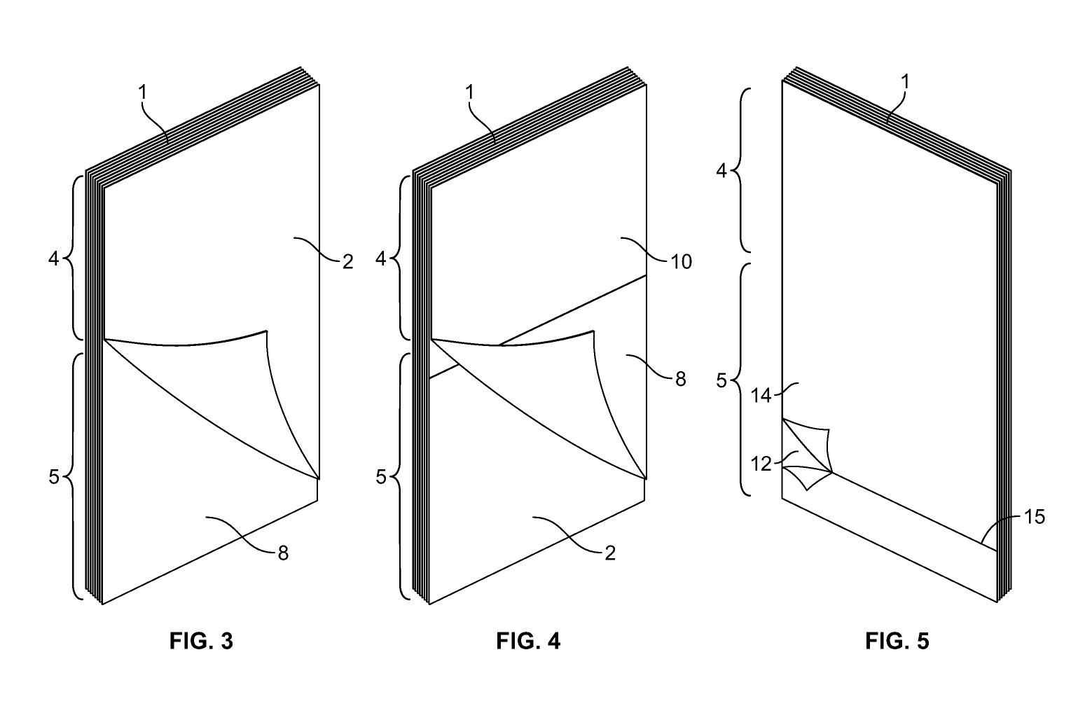

FIG. 5 illustrates an embodiment of the present invention comprising a backer sheet. The reverse side of stack 1 is shown, displaying the backer sheet 12. The reverse side of backer sheet 12 is entirely coated in adhesive, for better adhesion to surfaces considering it will support the weight of the entire calendar. In order to protect the adhesive during shipping and sale until it is time to be used, referred to as a first non-use mode, the reverse side of backer sheet 12 is covered with liner 14, which has back slit 15 cut through it for ease of removal during a second use mode, so that sections of the liner 14 may be removed easily and the backer sheet adhesive exposed for application to the surface. Back slit 15 may be positioned anywhere and in any configuration on liner 14 so long as it accomplishes the function of a back slit which is to facilitate the removal of liner 14. One type of backer sheet is the 7.4 mil tag, adhesive and protective liner available from NAStar Inc., Middleton, Wis. Backer sheet 12 may be sheeted and a back slit added on a Nilpeter™ FB3300.

A process of manufacture of the assembly of paper is also described. As indicated above, FIG. 1 a is a press diagram example of a prior art press that may be used to print the first side of calendar sheets 2, 8 shown in FIGS. 3 to 5. At least two images on adjacent printed sheets are different due to the digital reproduction technique employed by such a press. In FIG. 1b, the rollers of the press are illustrated, marked as prior art, to show the density of the rollers and demonstrate the difficulty with which paper already coated with adhesive would have passing through the press. As discussed above, adhesive coated sheets wrap around the press' printing rollers and will not sheet out properly.

In order to create the adhesive sheet assembly following printing on the press, it is necessary to first print the image using the press, and then pass the printed material through another printing press such as the Nilpeter™ FB3300, the schematics of which are shown in FIG. 2. While the first press described is a digital press and the second press is a label printing press, other presses are contemplated. Alternatively, the first and second presses may be mechanically and/or electrically linked into one press such that the process is continuous.

The sheets are printed in the reverse order from which they are to appear in the calendar. Once printed, they are reregistered on the printing press, which will reverse their order. A regular eye mark or other indicator is printed on the printed sheets so that the printing press may align and reregister the printed sheets. In other applications of the present invention, such as the photo album embodiment, the order of images or data may not be important.

The process for producing an adhesive calendar assembly requires that the calendars are printed on the first press and the backer sheets are cut; then, as mentioned above, the printed calendar is reregistered on the second press. During this part of the process, no further printing is done, but each calendar sheet is passed in reverse order as mentioned above through the second press and a portion of the reverse of sheets 2, 8 of printed paper is coated with a low-tack microsphere adhesive such as Franklin™ Adhesive Micromax™ 250 or other repositionable adhesive. As the now adhesive-coated sheets reach the end of the press path, they are cut into individual sheets and stacked on top of one another.

In one embodiment, a backer sheet is inserted at the bottom and then thirteen sheets, namely a cover and twelve months, are stacked on the backer sheet creating a complete calendar year. Other numbers of months are contemplated, such as beginning during the month of September of a given year and ending at the month of June the following year, which may be appropriate for school calendars. Furthermore, the timing of calendar sales may dictate the first and last month in the assembly.

The amount of coverage of repositionable adhesive is pre-determined using the skilled worker's knowledge of the printing press. In some applications, the complete sheet is coated and in others the sheet is partially coated. If differing amounts of coverage are required for each calendar sheet and the backer sheet, as in the embodiment described here, the backer sheets are prepared with an adhesive coating separately and are placed within the press, for insertion after every thirteenth page.

In one embodiment, the backer sheets are prepared with a full coverage of adhesive, having a liner over the adhesive to protect the adhesive and facilitate movement through the press. The backer sheets are then pre-cut and positioned in the label printing press. In this example, the calendar sheets may have half coverage of adhesive while the backer sheet has full coverage.

The adhesive can be coated using a flexographic, gravure or screen printing method or other known coating method, within the press. The web path shown in FIG. 2 illustrates a standard flexographic webbing. It can be seen that the adhesive is coated using a flexographic method within the label printing press. The calendars are then sheeted and the slip-sheet backer is inserted.

Therefore, in order to print the calendars in one embodiment of the present invention, the following steps are followed in one embodiment:
1. positioning a roll of chosen paper, for example a roll of 12.125″ wide 60 lb matte paper from Ariva, Mississauga on the unwind shaft of a digital press such as an HP™ Indigo™ ws4500;
2. ensuring that press ink and blankets are full and in good working order;
3. downloading the file of the desired product, for example a calendar, from a server or other computing device;
4. ensuring the images are printing in the correct order, for example a calendar would print in the order December, November, October, September, and so on so that it may later be reversed by the label printing press and assembled in the right order, with December below November in a calendar, for example;
5. ensuring the images are centered on the page and the eye mark is printing; and
6. if the first press is not connected to the second press, rolling up the printed material and moving it to the second printing press such as the Nilpeter™ FB3300 flexographic label printing press.

In order to prepare the liner sheets with a back slit to facilitate removal of the liner, the following steps are followed:
1. placing a roll of a backer sheet with liner, (for example 12.125″ NAStar™ Middleton, Wis. 7.4 pt temporary adhesive backer sheet sheeting with liner), on the unwind shaft of the press, for example the Nilpeter™ FB3300 label printing press;
2. positioning a 17″ rotary sheeting die (for example RotoMetrics™ Mississauga) in the sheeting station;
3. positioning a back slitter in the die station (for example, RotoMetrics™ Mississauga) which cuts the liner and makes removal of the liner from the backer sheet easier; and
4. running the press, wherein each backer sheet passes the back slitter and receives a back slit, and the prepared backer sheets are piled.

In order to coat the printed sheets with adhesive and assemble the calendars, the following steps are followed:
1. placing the 12.125″ roll of printed calendars on the unwind shaft of a label printing press such as the Nilpeter™ FB3300;
2. adding sheeted slip sheets to feeder on pile high stacker;
3. webbing the press with the printed calendars;
4. setting the eye mark on the reregistration unit for alignment and cut positioning;
5. adding a repositionable adhesive such as Franklin™ Micromax™ low-tack microsphere adhesive to the print station;
6. positioning an anilox roller in the print station for the adhesive, wherein coat weight can be changed by choosing anilox of the following sizes:
   a. for flexographic coating 100 line anilox (for example these are manufactured by CTS Industries); and
   b. for gravure or direct gravure a 360 anilox roller (again CTS Industries is one source of such an anilox roller);
7. positioning a tint roller, (for example, NarOweb Technologies, Bolton, Ontario) in the print station to coat the adhesive to the desired width. For a calendar it is preferred to coat the upper image portion, leaving the lower calendar portion free of adhesive so that a user can easily see a month underneath the month showing on the top sheet;
8. if coating using the flexographic method, the calendars are placed on the unwind shaft upside down and a turn bar is used to turn the stock back to printed side up;
9. positioning 17″ sheeter (RotoMetrics™ Mississauga) in sheeting station to cut the roll of paper into sheets;
10. setting the slip sheet inserter to insert slip sheet at the desired sheet count, which is thirteen in the case of common calendar configurations, however it may be 53 if a weekly calendar is designed, or 100 or more if the product is flashcards, for example;
11. running the press, which coats the reverse side of the sheets with adhesive and assembles the calendar or other sheet assembly such that the sheets adhere to one another, as well as a fully coated backer sheet at the back for mounting;
12. cutting to the desired size on a cutter (for example, a Polar™ 26 Cutter Germany) after the finished product is removed from the stacker; and
13. packaging and shipping the assembled product.

The processes of printing the images or data to a roll, then placing the roll on a press for application of the adhesive, sheeting, collating and assembly may be done with different machines or with one machine. The use of an HP™ Indigo^{™ ws}4500 is described above as accomplishing the digital press function, which prints two or more different images on the roll. This roll is then placed on the modified Nilpeter™ FB3300 as described above, for application of the repositionable adhesive, sheeting, collating and assembly with or without the optional backer sheet. Other processes are contemplated, prior to sheeting such as the application of braille or varnish to one or more sheets.

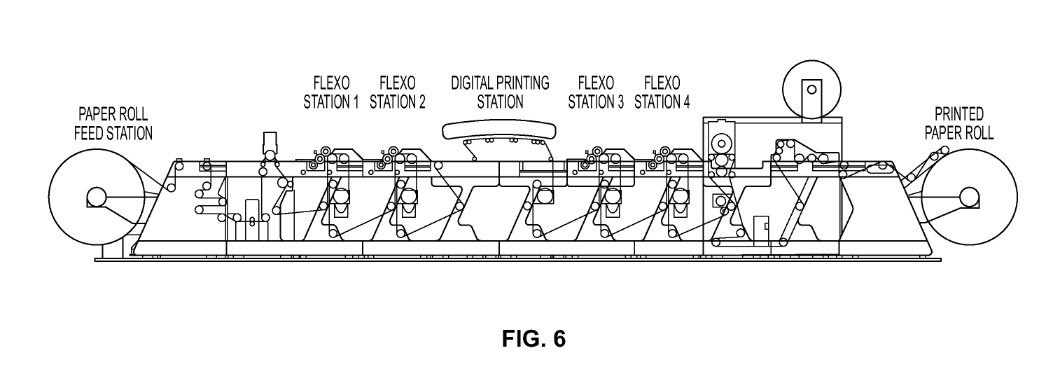

FIG. 6 illustrates one embodiment showing the combination of multiple processes into one machine. Flexo stations 1 and 2 may be the application of certain colours, according to the user's requirements. The printing station may be digital (as indicated in the figure) or by ink jet application for example. Flexo station 3 is the application of the repositionable adhesive. Flexo station 4, if required, may be an add-on process, such as the application of braille, varnish or other downstream process based on the user's requirements. The figure as illustrated ends with the spooling of the printed paper roll but, as previously described, the sheeting, collating and assembly function can replace the spooling.

Having thus described the present disclosure in detail, it is to be understood that the foregoing description is not intended to limit the scope thereof. What is desired to be protected is set forth in the following claims.

1. An assembly of adhesive sheets comprising two or more printed sheets, each sheet comprising a section of paper having an image or data printed on a first side and having a repositionable adhesive on at least a portion of a reverse side, wherein the sheets are assembled together so the front side of one sheet contacts the reverse side of an adjacent sheet, the adhesive detachably holds the sheets together, and the two or more printed sheets contain different images or data and are repositionable.

2. The assembly of claim 1 further comprising a backer sheet having a front side and a reverse side.

3. The assembly of claim 2 wherein said backer sheet comprises adhesive on the reverse side, the front side of said backer sheet detachably attached to the reverse side of the last of said two or more printed sheets.

4. The assembly of claim 3 wherein said backer sheet comprises a liner to protect the backer sheet adhesive.

5. The assembly of claim 1 wherein each sheet has an upper portion and a lower portion, and the adhesive is applied to the upper portion on the reverse side, and the lower portion of the reverse side has no adhesive.

6. The assembly of claim 1 wherein the image or data is selected from the group consisting of calendar data, flashcards, cartoons, coupons, photos, art, numbers, symbols and letters.

7. The assembly of claim 1 wherein the sheets are printed on a digital press.

8. The assembly of claim 1 wherein the repositionable adhesive is low-tack microsphere adhesive.

9. The assembly of claim 1 wherein the assembly is selected from the group consisting of a monthly calendar, a weekly calendar, and a daily calendar.

10. A process for creating an assembly of adhesive sheets, the process comprising:
a. placing a roll within a printing press having one or more print stations, said roll comprising two or more different images or data printed thereon;
b. webbing the press with the roll;
c. setting an eye mark on a reregistration unit of the printing press for alignment and cut positioning;
d. adding a repositionable adhesive to the printing press;
e. positioning an anilox or coating roller in the print station for the adhesive;
f. positioning a tint or coating roller in the print station to coat the adhesive to a desired width and thickness;
g. positioning a sheeter in a sheeting station;
h. coating at least a portion of the reverse side of the sheets with the adhesive;
i. cutting the images or data into separate sheets; and
j. assembling the sheets into an assembly such that the sheets adhere to one another.

11. The process of claim 10 wherein the anilox roller is a 100 line anilox roller for flexographic coating.

12. The process of claim 10 wherein the anilox roller is a 360 line anilox roller for gravure or direct gravure.

13. The process of claim 10 wherein the sheets are placed on an unwind shaft of the printing press with the image or data side down and a turn bar is used to turn the images right side up when coating using a flexographic method.

14. The process of claim 10 further comprising the step of ensuring the order of the printed sheets is consecutive, such that the order will be reversed and correct after passing through the printing press.

15. The process of claim 10 further comprising the step of cutting the assembly to a desired size on a cutter after the assembly is removed from the stacker.

16. The process of claim 10 further comprising the step of printing the said two or more images or data on the roll, before step a.

17. The process of claim 10 further comprising, after step h): applying braille to one or more sheets.

18. The process of claim 10 further comprising, after step h): applying varnish to one or more sheets.

19. The process of claim 13 further comprising the steps of:
k. placing a roll of a backer sheet with slip sheet on the unwind shaft of the printing press;
l. positioning a rotary sheeting die in the sheeting station;
m. positioning a back slitter in the die station to cut the back slip; and
n. passing each backer sheet through the back slitter to receive a back slit;
o. adding the resulting backer sheets with back slits to the printing press for insertion into the assembly; and
p. setting the backer sheet inserter to insert a backer sheet at a desired sheet count.
